(19) United States
(12) Patent Application Publication
(10) Pub. No.: US 2023/0269213 A1
(43) Pub. Date: Aug. 24, 2023

(54) CLIENT-TO-CLIENT MESSAGE SYNCHRONIZATION

(71) Applicant: WhatsApp LLC, Menlo Park, CA (US)

(72) Inventors: Christopher Luc, Toronto (CA); Alisdair Henry Johnstone, Taunton (GB); Colin Clemmons, Oakland, CA (US); Ethan Thomas Bold, San Francisco, CA (US); Ruichen Ma, Fremont, CA (US)

(21) Appl. No.: 18/087,624

(22) Filed: Dec. 22, 2022

Related U.S. Application Data
(60) Provisional application No. 63/312,761, filed on Feb. 22, 2022.

(51) Int. Cl. H04L 51/42

(52) U.S. Cl. CPC H04L 51/42

(57) ABSTRACT

Methods, systems, and storage media client-to-client message synchronization are disclosed. Exemplary implementations may: in response to an indication of a state change for a state of an account on a first device being received through a user interface of the first device, receive the indication of the state change from the first device at a second device; update a state of the account on the second device based on the indication of the state change for the account on the first device; and cause display of a view of the user interface of the messaging application on the second device reflecting the updated state of the account on the second device.

### CROSS REFERENCE TO RELATED APPLICATIONS

This application claims priority under 35 U.S.C. § 119(e) to U.S. patent application Ser. No. 63/312,761 filed Feb. 22, 2022, the disclosures of which applications are incorporated by reference herein, in their entirety, for all purposes.

### TECHNICAL FIELD

The present disclosure generally relates to client-to-client message synchronization, and more particularly to synchronizing message between two user devices accessing the same account on an end-to-end encrypted messaging platform.

### BACKGROUND

End-to-end encryption may include systems of communication where only the communicating users can read messages shared between them. End-to-end encryption may prevent potential eavesdroppers (e.g., telecom providers, Internet providers, malicious actors, and providers of the communication service) from being able to access the cryptographic keys needed to decrypt the conversation. End-to-end encryption may prevent data being read or modified, other than by the true sender and recipient(s). The messages may be encrypted by a sender, but third parties may not have a means to decrypt them and may store the messages in encrypted form. The recipient(s) may retrieve the encrypted data and decrypt it themselves.

### BRIEF SUMMARY

The subject disclosure provides for systems and methods for client-to-client message synchronization. A user is allowed to simultaneously access their account for an end-to-end messaging platform from multiple devices, make a change on one device, and have that change reflected on the other device(s). For example, if the user marked a message as read on one of their devices, the message would be shown as read on any other device through which the user accessed their account. Moreover, any intermediate server cannot read the change being made.

One aspect of the present disclosure relates to a method client-to-client message synchronization. The method may include, in response to an indication of a state change for a state of an account on a first device being received through a user interface of the first device, receiving the indication of the state change from the first device at a second device. The account may be for a messaging application. The second device may have access to the account. The method may include updating a state of the account on the second device based on the indication of the state change for the account on the first device. The method may include causing display of a view of the user interface of the messaging application on the second device reflecting the updated state of the account on the second device.

Another aspect of the present disclosure relates to a system configured client-to-client message synchronization. The system may include one or more hardware processors configured by machine-readable instructions. The processor(s) may be configured to, in response to an indication of a state change for a state of an account on a first device being received through a user interface of the first device, receive the indication of the state change from the first device at a second device. The account may be for a messaging application. The second device may have access to the account. The state may include one or more of thread deleted, message deleted, message deleted for me, thread archived, thread marked as read, and/or thread marked as unread. The indication of the state change may be encrypted by the first device. The second device may decrypt the encrypted indication of the state change. The processor(s) may be configured to update a state of the account on the second device based on the indication of the state change for the account on the first device. The processor(s) may be configured to cause display of a view of the user interface of the messaging application on the second device reflecting the updated state of the account on the second device.

Yet another aspect of the present disclosure relates to a non-transient computer-readable storage medium having instructions embodied thereon, the instructions being executable by one or more processors to perform a method client-to-client message synchronization. The method may include, in response to an indication of a state change for a state of an account on a first device being received through a user interface of the first device, receiving the indication of the state change from the first device at a second device. The account may be for a messaging application. The second device may have access to the account. The state may include one or more of thread deleted, message deleted, message deleted for me, thread archived, thread marked as read, and/or thread marked as unread. The state change may include a transition from a first state to a second state. The indication of the state change may be encrypted by the first device. The second device may decrypt the encrypted indication of the state change. The first device and the second device may be communicatively couple via an end-to-end encrypted channel. The method may include updating a state of the account on the second device based on the indication of the state change for the account on the first device. Any intermediate servers between the first device and the second device may be unable to read state change information from the end-to-end encrypted channel. The method may include causing display of a view of the user interface of the messaging application on the second device reflecting the updated state of the account on the second device.

Still another aspect of the present disclosure relates to a system configured client-to-client message synchronization. The system may include means for, in response to an indication of a state change for a state of an account on a first device being received through a user interface of the first device, receiving the indication of the state change from the first device at a second device. The account may be for a messaging application. The second device may have access to the account. The system may include means for updating a state of the account on the second device based on the indication of the state change for the account on the first device. The system may include means for causing display of a view of the user interface of the messaging application on the second device reflecting the updated state of the account on the second device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an overview of an environment in which some implementations of the disclosed technology can operate.

FIG. 2 illustrates a process for client-to-client message synchronization between a first client and a second client without using a central server as a source of truth, in accordance with one or more implementations.

FIGS. 3A, 3B, 3C, 3D, 3E, 3F, and/or 3G illustrate example views of a user interface for a chat application configured to perform a process for client-to-client message synchronization without using a central server as a source of truth, in accordance with one or more implementations.

FIG. 4 illustrates a system configured for client-to-client message synchronization, in accordance with one or more implementations.

FIG. 5 illustrates an example flow diagram for client-to-client message synchronization, according to certain aspects of the disclosure.

FIG. 6 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

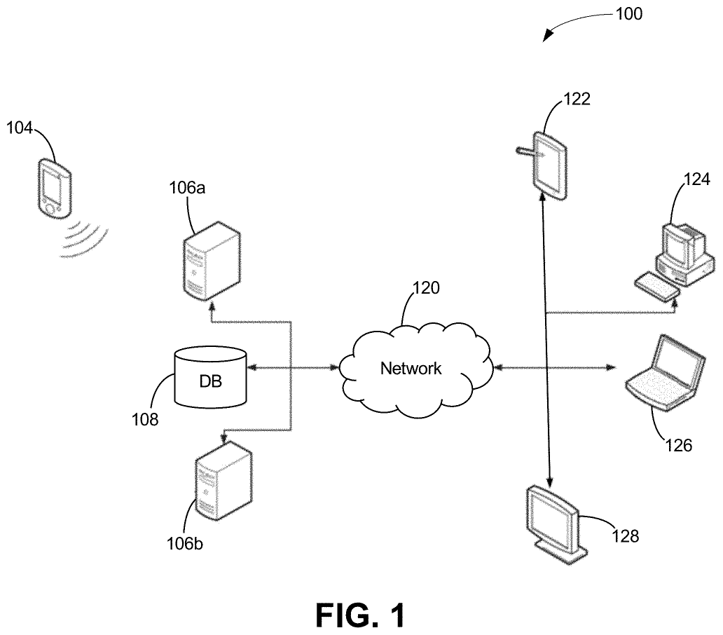

FIG. 1 is a block diagram illustrating an overview of an environment 100 in which some implementations of the disclosed technology can operate. The environment 100 can include one or more client computing devices, mobile device 104, tablet 112, personal computer 124, laptop 126, desktop 128, and/or the like. Client devices may communicate wirelessly via the network 110. The client computing devices can operate in a networked environment using logical connections through network 110 to one or more remote computers, such as server computing devices. The server computing devices 106a-106b may be configured to show (e.g., make encrypted content visible) content to one or more of the client computing devices for those client computing devices that presented a correct public key. As an example, the server computing devices 106a-106b can include a database (e.g., database 108) that tracks which users of the client computing devices have granted access to their encrypted content (e.g., encrypted by corresponding privately held private keys) to other client users.

In some implementations, the environment 100 may include a server such as an edge server which receives client requests and coordinates fulfillment of those requests through other servers. The server may include the server computing devices 106a-106b, which may logically form a single server. Alternatively, the server computing devices 106a-106b may each be a distributed computing environment encompassing multiple computing devices located at the same or at geographically disparate physical locations. The client computing devices and server computing devices 106a-106b can each act as a server or client to other server/client device(s). The server computing devices 106a-106b can connect to a database 108 or can comprise its own memory. Each server computing devices 106a-106b can correspond to a group of servers, and each of these servers can share a database 108 or can have their own database 108. The database 108 may logically form a single unit or may be part of a distributed computing environment encompassing multiple computing devices that are located within their corresponding server, located at the same, or located at geographically disparate physical locations. The database 108 can store data indicative of keys or access granted by a given user to other users of the given user's encrypted content and/or shared messaging platform content that can be subscribed to by other users. The database 108 may also be used to facilitate key rotation in a one-to-many encryption architecture by causing issue of new keys when a copy of a shared key becomes comprised, for example.

The network 120 can be a local area network (LAN), a wide area network (WAN), a mesh network, a hybrid network, or other wired or wireless networks. The network 110 may be the Internet or some other public or private network. Client computing devices can be connected to network 120 through a network interface, such as by wired or wireless communication. The connections can be any kind of local, wide area, wired, or wireless network, including the network 120 or a separate public or private network. In some implementations, the server computing devices 106a-106b can be used as part of a messaging platform such as implemented via the network 120. The messaging platform can host content and protect access to the content, such as via the database 108, although the server computing devices 106a-106b of the messaging platform do not have access to private keys and can be remote/separate from the application(s) that perform key generation and content encryption. The messaging platform can facilitate private communications between users through end-to-end encryption. For example, all messages that pass from one user to another user through the messaging platform may be encrypted. The messages may only be decrypted at user devices of the sending and/or receiving user. A private key required to decrypt the encrypted messages may be stored at the user devices. The messages may contain content items. Content items can be any digital data such as text, images, audio, video, links, webpages, minutia (e.g., indicia provided from a client device such as emotion indicators, status text snippets, location indictors, etc.), or other multi-media.

Conventional messaging platforms (i.e., without end-to-end encryption) typically store state information at a central server such that different devices accessing the same account display the most current state information when they access the account. In end-to-end encrypted messaging platforms, however, information that passes through such a central server is encrypted. Thus, a central server in an end-to-end encrypted messaging platform cannot be relied upon to manage state information for an account being simultaneously accessed and updated through multiple devices

The subject disclosure provides for systems and methods for client-to-client message synchronization. A user is allowed to simultaneously access their account for an end-to-end messaging platform from multiple devices, make a change on one device, and have that change reflected on the other device(s). For example, if the user marked a message as read on one of their devices, the message would be shown as read on any other device through which the user accessed their account. Moreover, any intermediate server cannot read the change being made.

Implementations described herein address the aforementioned shortcomings and other shortcomings by providing in client-to-client message synchronization, including an end-to-end encrypted messaging platform, such that any intermediate servers are not required. For example, aspects provide support for synchronizing a messaging application state between peer devices on the same account through an end-to-end encrypted channel. That is, when Alice has two devices logged into the same account, when she deletes a thread on one device, that thread should appear deleted on her other device, too, without requiring a central server.

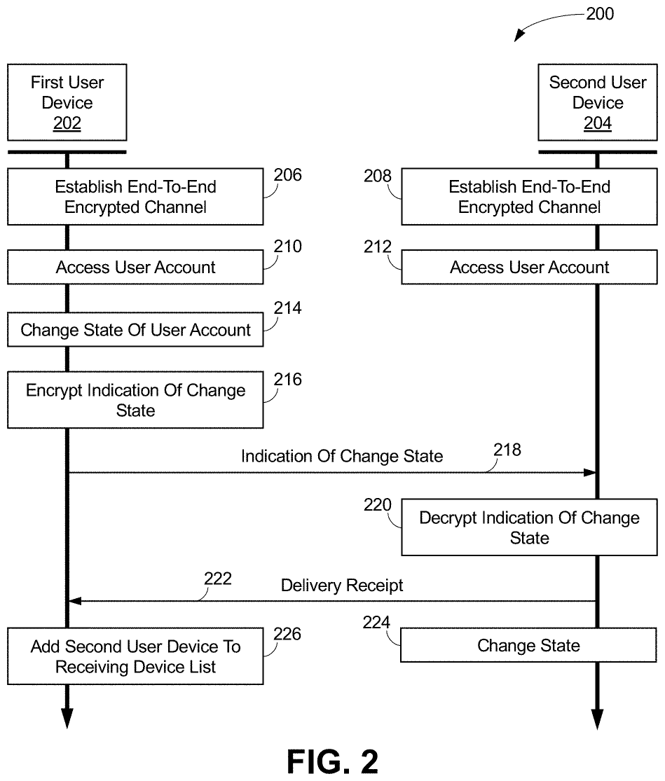

FIG. 2 illustrates a process 200 for client-to-client message synchronization between a first client (i.e., first user device 202) and a second client (i.e., second user device 204) without using a central server as a source of truth, in accordance with one or more implementations. At a steps 206 and 208, the first user device 202 and the second user device 204, respectively, establish an end-to-end encrypted channel between each other. Any intermediate server between the first user device 202 and the second user device 204 cannot decrypt and/or otherwise access encrypted information communicated therebetween. At a steps 210 and 212, the first user device 202 and the second user device 204, respectively, access a same user account (e.g., an account of an end-to-end encrypted messaging platform). At a step 214, a state of the user account is changed on the first user device 202. The state may include one or more of thread deleted, message deleted, thread archived, thread marked as read, thread marked as unread, and/or other states. The state change may include a transition for a first state to a second state. The state may be changed in response to one or more of receipt of a user selection (e.g., marking a message as read), an activity of a user (e.g., opening a message), and/or other triggers. At a step 216, an indication of the state change is encrypted by the first user device 202. At a step 218, the encrypted indication of the state change is sent by the first user device 202 to the second user device 204. At a step 220, the second user device 204 decrypts the encrypted indication of the state change. At a step 222, a delivery receipt is sent by the second user device 204 to the first user device 202. At a step 224, a state of the user account is changed on the second user device 204. At a step 226, the first user device 202 adds the second user device 204 to a receiving device list.

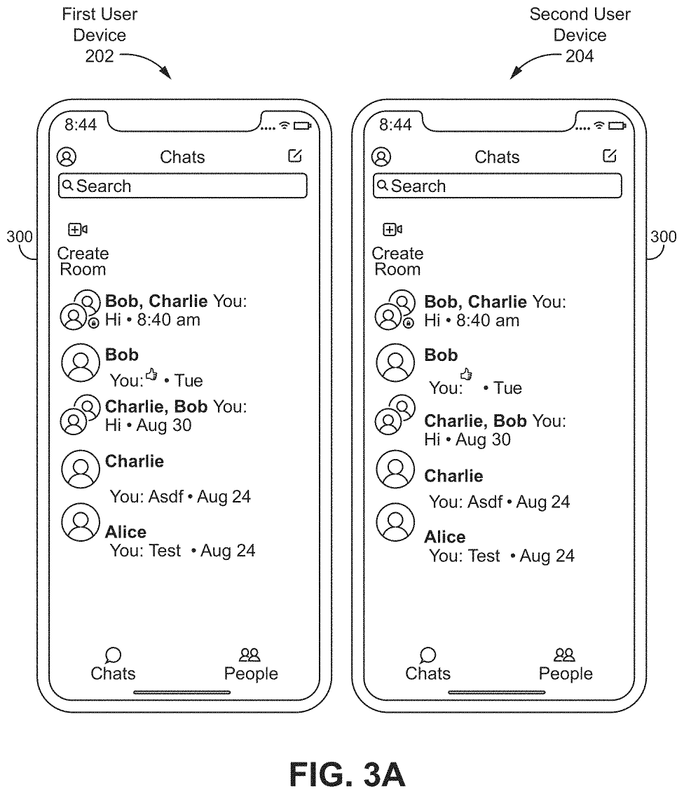

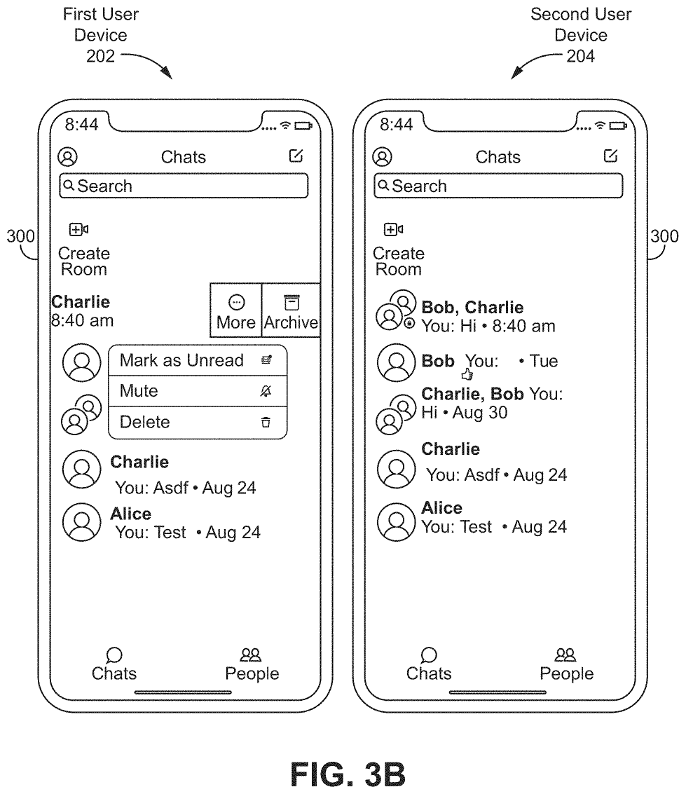

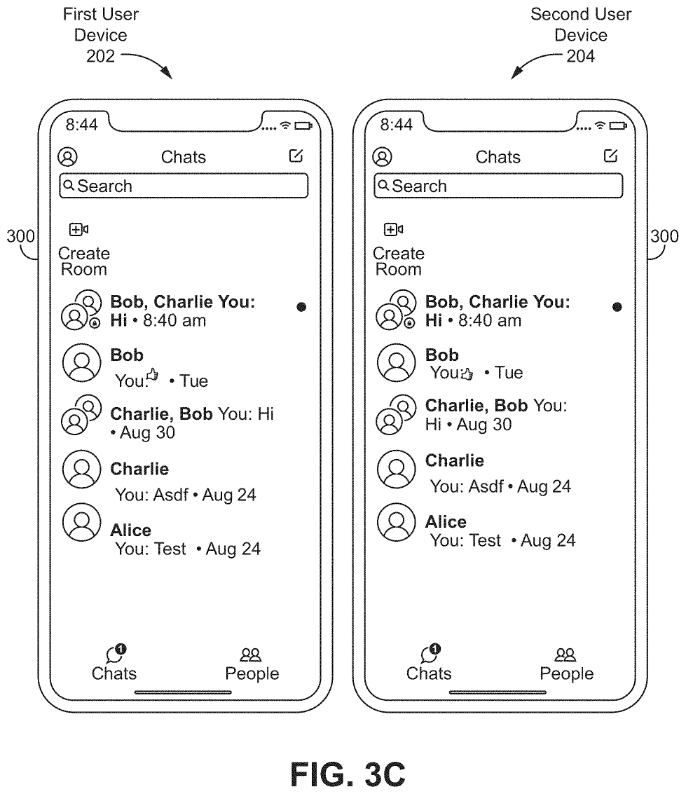

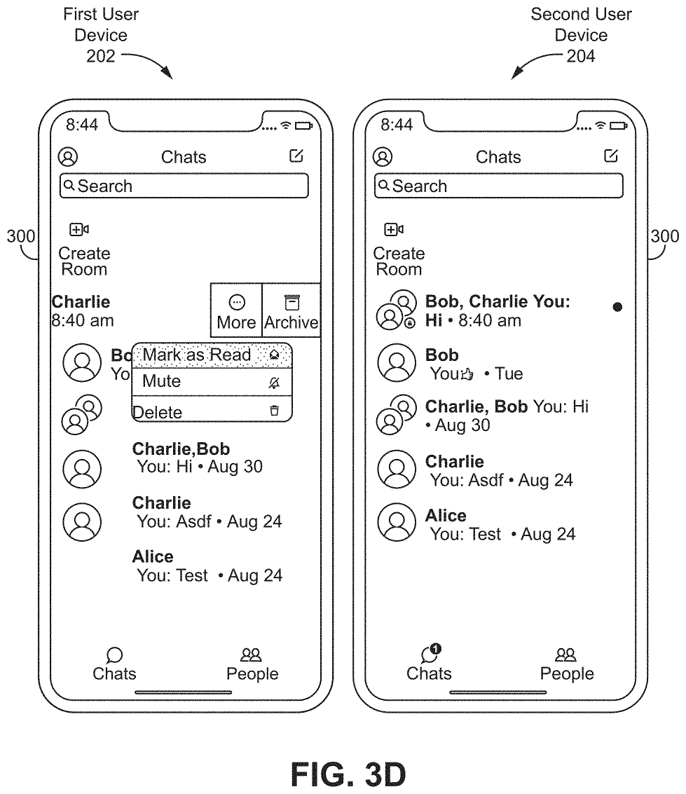

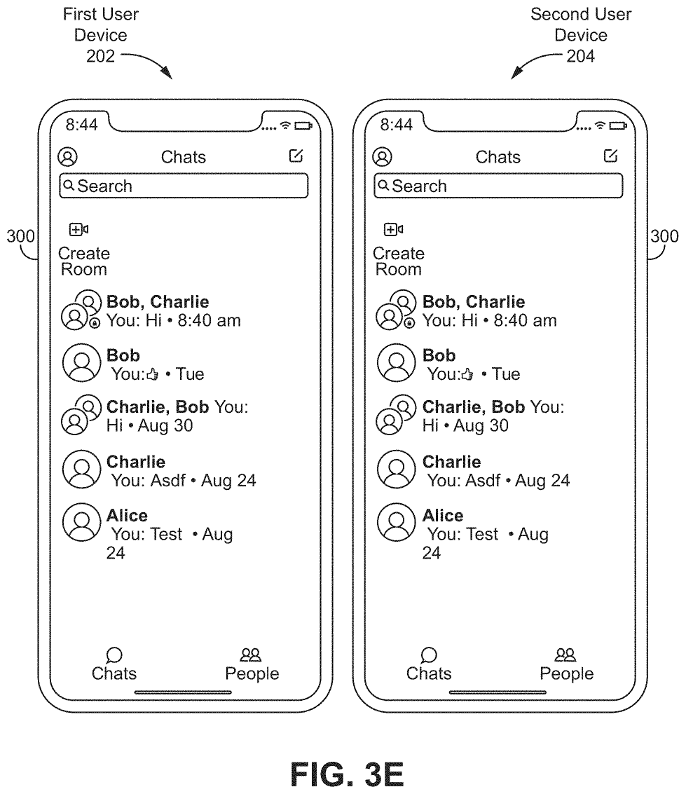

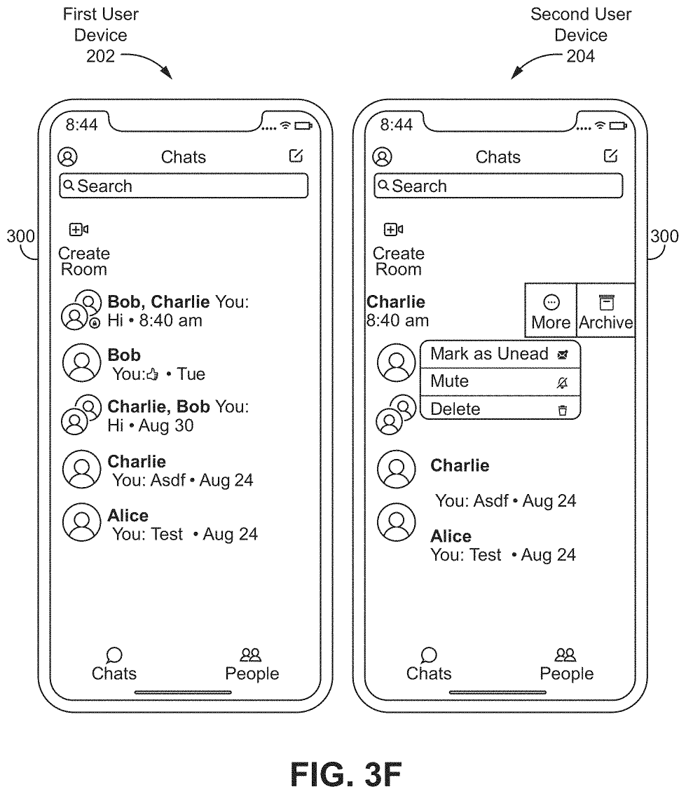

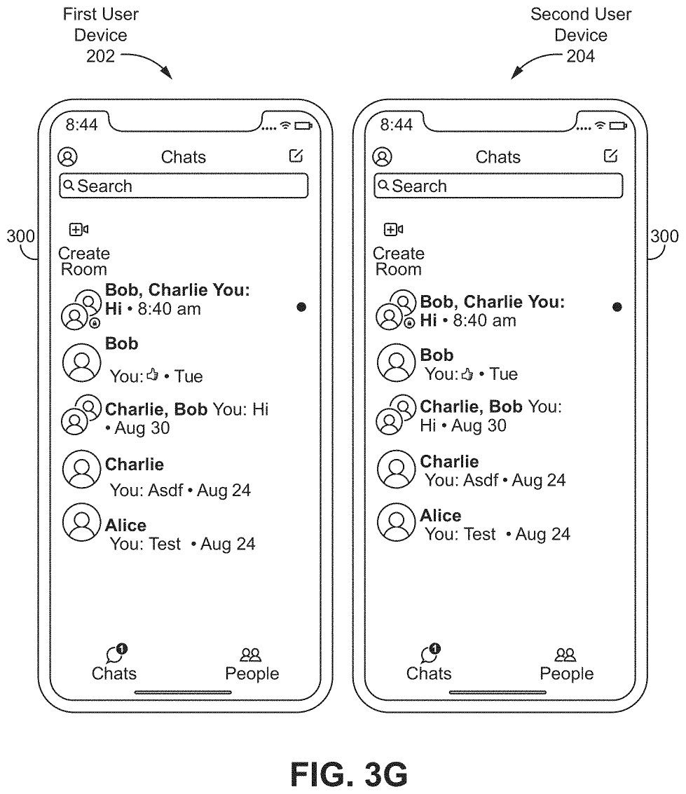

FIGS. 3A, 3B, 3C, 3D, 3E, 3F, and/or 3G illustrate example views of a user interface 300 for a chat application displayed via the first user device 202 and the second user device 204 (see FIG. 2) and configured to perform a process for client-to-client message synchronization without using a central server as a source of truth, in accordance with one or more implementations. FIG. 3A illustrates an example implementation in which the first user device 202 and the second user device 204 both belong to the same user having the same account on both devices. A chat summary is reflected on both devices. As shown, all chats have been marked as read.

FIG. 3B illustrates the user marking a chat as unread on the first user device 202. FIG. 3C illustrates the chat being marked as unread on the first user device 202, as well as the second user device 204. This is because the second user device 204 receives an indication from the first user device 202 of a state change in the chat summary. Once the indication is received by the second user device 204, the second user device 204 also updates the chat as being marked unread as well.

FIG. 3D illustrates the user marking the chat as read on the first user device 202. FIG. 3E illustrates the chat being marked as read on both the first user device 202 and the second user device 204. This is because the second user device 204 received the indication of the state change from the first user device 202. The second user device 204 updates the chat as being marked read also.

FIG. 3F illustrates the user marking the chat as unread on the second user device 204. FIG. 3G illustrates the chat being marked as read on both the first user device 202 and the second user device 204. This is because the first user device 202 received the indication of the state change from the second user device 204. The first user device 202 updates the chat as being marked read as well.

The disclosed system(s) address a problem in traditional client-to-client synchronization techniques tied to computer technology, namely, the technical problem of synchronizing devices contemporaneously accessing a same account on an end-to-end messaging platform. The disclosed system solves this technical problem by providing a solution also rooted in computer technology, namely, by providing for synchronizing message between two user devices accessing the same account on an end-to-end encrypted messaging platform. The disclosed subject technology further provides improvements to the functioning of the computer itself because it improves processing and efficiency in client-to-client message synchronization.

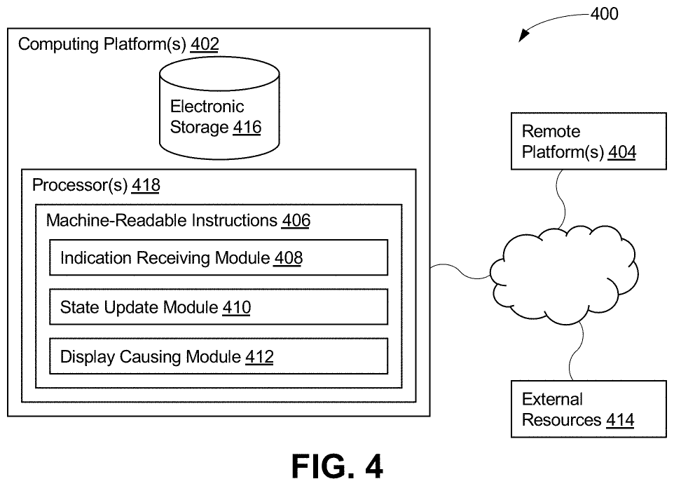

FIG. 4 illustrates a system 400 configured for client-to-client message synchronization, according to certain aspects of the disclosure. In some implementations, system 400 may include one or more computing platforms 402. Computing platform(s) 402 may be configured to communicate with one or more remote platforms 404 according to a client/server architecture, a peer-to-peer architecture, and/or other architectures. Remote platform(s) 404 may be configured to communicate with other remote platforms via computing platform(s) 402 and/or according to a client/server architecture, a peer-to-peer architecture, and/or other architectures. Users may access system 400 via remote platform(s) 404.

Computing platform(s) 402 may be configured by machine-readable instructions 406. Machine-readable instructions 406 may include one or more instruction modules. The instruction modules may include computer program modules. The instruction modules may include one or more of indication receiving module 408, state update module 410, display causing module 412, and/or other instruction modules.

Indication receiving module 408 may be configured to, in response to an indication of a state change for a state of an account on a first device being received through a user interface of the first device, receive the indication of the state change from the first device at a second device. The account may be for a messaging application. The second device may have access to the account. The state change may include a transition from a first state to a second state. The indication of the state change may include a data stanza that is only communicable between peer devices. The peer devices may include the first device and the second device. The indication of the state change may be encrypted.

The indication of the state change may be encrypted by the first device. The second device may decrypt the encrypted indication of the state change. The second device may send a delivery receipt in response to the second device successfully decrypting the encrypted indication of the state change. The second device may send a retry receipt in response to the second device unsuccessfully decrypting the encrypted indication of the state change. By way of non-limiting example, undelivered indications of state changes may be pruned from an offline queue after breaching one or more of a threshold duration, a threshold number of retries, and/or a threshold number of indications of state changes. Indications of state changes of a same type may be merged if being processed contemporaneously.

The first device and the second device may be associated with a same user. The first device and the second device may be communicatively couple via an end-to-end encrypted channel. The indication of the state change for the account on the first device may be received at the second device via the end-to-end encrypted channel. Any intermediate servers between the first device and the second device may be unable to read state change information from the end-to-end encrypted channel.

State update module 410 may be configured to update a state of the account on the second device based on the indication of the state change for the account on the first device. The state may include a current condition of the account regarding stored inputs as to values or contents. By way of non-limiting example, the state may include one or more of thread deleted, message deleted, thread archived, thread marked as read, and/or thread marked as unread. The first device may determine a receiving device list that includes the second device and any additional devices that access the account such that newly added devices are caught up as to any state changes for the state of the account of the first device. Updating the state of the account on the second device may include transitioning the state of the account on the second device from a first state to a second state.

The state update module 410 can be configured to resolve conflicts between threads on two separate devices. In a further aspect, the state update module can resolve conflicts for state other than threads. Conflict resolution can be initiated for a particular message or account. In yet a further aspect, the state update module can initiate a resolution based on any discrepancy in state between any number of devices. Conflicts can occur when separate devices change a state at the same time or when an offline device receives multiple state synchronizations.

In one embodiment, resolving conflicts can comprise merging the same type of synchronization actions. In another embodiment, the state update module 410 can determine the differing states on devices can initiate differing synchronization actions needed for the respective devices to bring the respective devices to a consistent state. For example, when a message range is deleted and another message range is archived that overlaps with deleted messages, the state update module can resolve which of the messages are affected by these different actions (e.g. deleting versus archiving). Further, the state update module 410 can comprise an action storage submodule to monitor and keep track of actions until the state update module has finished applying each synchronization action. The action storage submodule can keep the synchronization actions after initial completion for a short grace period in the event out of order messages arrive. Maintaining the synchronization actions in storage during length of the grace period can also be contingent on the state update module repeating the synchronization actions to create state consistency between the various devices.

In a further aspect, to complete the multiple synchronization actions, the submodule can: i) schedule a device synchronization between all the devices associated with the account ii) verify the incoming message path to determine the impacted devices for synchronization; iii) decrypt the message; and iv) create reference objects associated with each synchronization action. Further, the submodule can call a sub-action for each new arriving synchronization action, wherein a reference object can also be attached to each sub-action for potential recall.

In another aspect, the state update module can comprise a conflict resolver submodule. The conflict resolver can determine or receive a determination whether devices associated with a communication are online or offline. When there is a conflict in synchronized data, the resolver submodule can initiate a protocol such that the most recent synchronization action takes precedent. The resolver submodule can also recover from a conflict by re-applying a synchronization action (re-deleting a thread, marking as read, etc.). In another aspect, the resolver submodule can initiate other strategies, other than recency of the action, to resolve conflicts. For example, the resolver submodule can initiate a ranking strategy. For example, predetermined synchronization action has higher precedence than another action. The ranking strategy can also be based on messages, such that if there is a message range, the range that encapsulates or encompasses a range can take precedent.

The resolver submodule can also address conflicts when a user modifies metadata while a device is offline. When the user brings the device back online, the device may receive conflicting actions from other devices. The resolver submodule can then process the differences between threads on each device associated with the client devices to bring them into a consistent state. In an exemplary synchronization sequence example, a first client device (Bob 1) can be initially offline. A second client device associated with Bob (Bob 2) is online and receives messages A, B, and C from Alice. Then Bob 2 deletes the thread of messages A, B, C and also receives messages D, E, F from Alice. Bob 1 can then come online after messages D, E, F. In resolving the conflict of messages on the two Bob devices, Bob 1 receives A, B, C, D, E, F, and initiates an action to delete Alice's thread after message timestamp C (e.g. the timestamp of message C), resulting in Bob 1 displaying messages D, E, and F. Display causing module 412 may be configured to cause display of a view of the user interface of the messaging application on the second device reflecting the updated state of the account on the second device.

In some implementations, computing platform(s) 402, remote platform(s) 404, and/or external resources 414 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 402, remote platform(s) 404, and/or external resources 414 may be operatively linked via some other communication media.

A given remote platform 404 may include one or more processors configured to execute computer program modules. The computer program modules may be configured to enable an expert or user associated with the given remote platform 404 to interface with system 400 and/or external resources 414, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms.

External resources 414 may include sources of information outside of system 400, external entities participating with system 400, and/or other resources. In some implementations, some or all of the functionality attributed herein to external resources 414 may be provided by resources included in system 400.

Computing platform(s) 402 may include electronic storage 416, one or more processors 418, and/or other components. Computing platform(s) 402 may include communication lines, or ports to enable the exchange of information with a network and/or other computing platforms. Illustration of computing platform(s) 402 in FIG. 4 is not intended to be limiting. Computing platform(s) 402 may include a plurality of hardware, software, and/or firmware components operating together to provide the functionality attributed herein to computing platform(s) 402. For example, computing platform(s) 402 may be implemented by a cloud of computing platforms operating together as computing platform(s) 402.

Electronic storage 416 may comprise non-transitory storage media that electronically stores information. The electronic storage media of electronic storage 416 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). Electronic storage 416 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 416 may include one or more virtual storage resources (e.g., cloud storage, a virtual private network, and/or other virtual storage resources). Electronic storage 416 may store software algorithms, information determined by processor(s) 418, information received from computing platform(s) 402, information received from remote platform(s) 404, and/or other information that enables computing platform(s) 402 to function as described herein.

Processor(s) 418 may be configured to provide information processing capabilities in computing platform(s) 402. As such, processor(s) 418 may include one or more of a digital processor, an analog processor, a digital circuit designed to process information, an analog circuit designed to process information, a state machine, and/or other mechanisms for electronically processing information. Although processor(s) 418 is shown in FIG. 4 as a single entity, this is for illustrative purposes only. In some implementations, processor(s) 418 may include a plurality of processing units. These processing units may be physically located within the same device, or processor(s) 418 may represent processing functionality of a plurality of devices operating in coordination. Processor(s) 418 may be configured to execute modules 408, 410, and/or 412, and/or other modules. Processor(s) 418 may be configured to execute modules 408, 410, and/or 412, and/or other modules by software; hardware; firmware; some combination of software, hardware, and/or firmware; and/or other mechanisms for configuring processing capabilities on processor(s) 418. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, and/or 412 are illustrated in FIG. 4 as being implemented within a single processing unit, in implementations in which processor(s) 418 includes multiple processing units, one or more of modules 408, 410, and/or 412 may be implemented remotely from the other modules. The description of the functionality provided by the different modules 408, 410, and/or 412 described below is for illustrative purposes, and is not intended to be limiting, as any of modules 408, 410, and/or 412 may provide more or less functionality than is described. For example, one or more of modules 408, 410, and/or 412 may be eliminated, and some or all of its functionality may be provided by other ones of modules 408, 410, and/or 412. As another example, processor(s) 418 may be configured to execute one or more additional modules that may perform some or all of the functionality attributed below to one of modules 408, 410, and/or 412.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

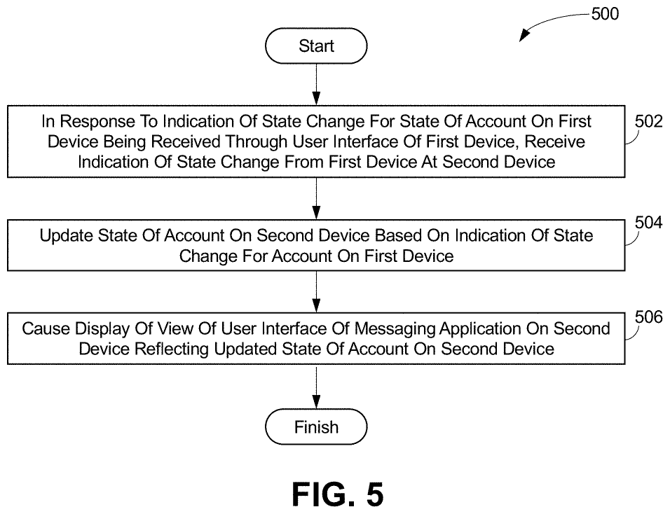

FIG. 5 illustrates an example flow diagram (e.g., process 500) for client-to-client message synchronization, according to certain aspects of the disclosure. For explanatory purposes, the example process 500 is described herein with reference to FIGS. 1-4. Further for explanatory purposes, the steps of the example process 500 are described herein as occurring in serial, or linearly. However, multiple instances of the example process 500 may occur in parallel. For purposes of explanation of the subject technology, the process 500 will be discussed in reference to FIGS. 1-4.

At step 502, the process 500 may include in response to an indication of a state change for a state of an account on a first device being received through a user interface of the first device, receiving the indication of the state change from the first device at a second device. The account may be for a messaging application. The second device may have access to the account. At step 504, the process 500 may include updating a state of the account on the second device based on the indication of the state change for the account on the first device. At step 506, the process 500 may include causing display of a view of the user interface of the messaging application on the second device reflecting the updated state of the account on the second device.

For example, as described above in relation to FIG. 4, at step 502, the process 500 may include in response to an indication of a state change for a state of an account on a first device being received through a user interface of the first device, receiving the indication of the state change from the first device at a second device, through indication receiving module 408. The account may be for a messaging application. The second device may have access to the account. At step 504, the process 500 may include updating a state of the account on the second device based on the indication of the state change for the account on the first device, through state update module 410. At step 506, the process 500 may include causing display of a view of the user interface of the messaging application on the second device reflecting the updated state of the account on the second device, through display causing module 412.

According to an aspect, the state includes one or more of thread deleted, message deleted, message deleted for me, thread archived, thread marked as read, and/or thread marked as unread. In a further aspect, when a thread is deleted other messages associated with the thread can be deleted as an additional privacy measure.

According to an aspect, the state change includes a transition from a first state to a second state.

According to an aspect, the indication of the state change is encrypted by the first device.

According to an aspect, the second device decrypts the encrypted indication of the state change.

According to an aspect, the second device sends a delivery receipt in response to the second device successfully decrypting the encrypted indication of the state change.

According to an aspect, the first device determines receiving device list that includes the second device and any additional devices that access the account such that newly added devices are caught up as to any state changes for the state of the account of the first device.

According to an aspect, the first device and the second device are associated with a same user.

According to an aspect, the first device and the second device are communicatively couple via an end-to-end encrypted channel.

According to an aspect, any intermediate servers between the first device and the second device are unable to read state change information from the end-to-end encrypted channel.

According to an aspect, messages can be deleted based on a timestamp. The timestamp can be a server timestamp of the newest message or a timestamp of when the server received the delete action.

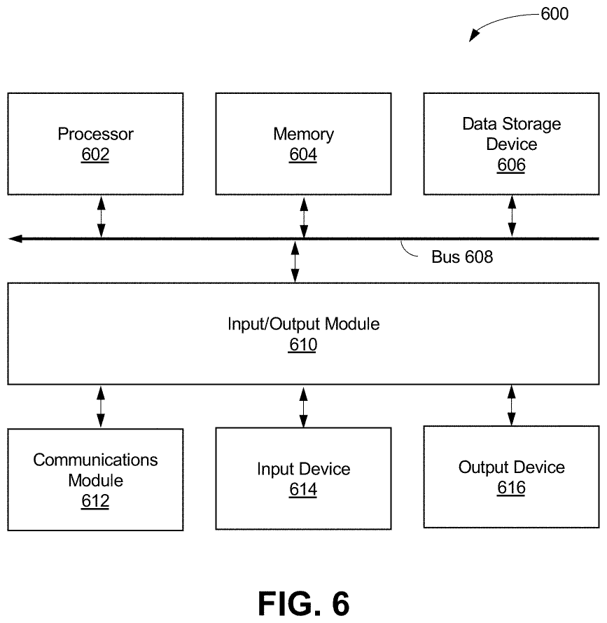

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities.

Computer system 600 (e.g., server and/or client) includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer-readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor, for displaying information to the user.

According to one aspect of the present disclosure, the above-described gaming systems can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads game data and provides a game, information may be read from the game data and stored in a memory device, such as the memory 604. Additionally, data from the memory 604 servers accessed via a network the bus 608, or the data storage 606 may be read and loaded into the memory 604. Although data is described as being found in the memory 604, it will be understood that data does not have to be stored in the memory 604 and may be stored in other memory accessible to the processor 602 or distributed among several media, such as the data storage 606.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method client-to-client message synchronization, the method comprising:
in response to an indication of a state change for a state of an account on a first device being received through a user interface of the first device, receiving the indication of the state change from the first device at a second device, the account being for a messaging application, the second device having access to the account;
updating a state of the account on the second device based on the indication of the state change for the account on the first device; and
causing display of a view of the user interface of the messaging application on the second device reflecting the updated state of the account on the second device.

2. The method of claim 1, wherein the state includes one or more of thread deleted, message deleted, message deleted for me, thread archived, thread marked as read, and/or thread marked as unread.

3. The method of claim 1, wherein the state change includes a transition from a first state to a second state.

4. The method of claim 1, wherein the indication of the state change is encrypted by the first device.

5. The method of claim 4, wherein the second device decrypts the encrypted indication of the state change.

6. The method of claim 5, wherein the second device sends a delivery receipt in response to the second device successfully decrypting the encrypted indication of the state change.

7. The method of claim 1, wherein the first device determines receiving device list that includes the second device and any additional devices that access the account such that newly added devices are caught up as to any state changes for the state of the account of the first device.

8. The method of claim 1, wherein the first device and the second device are associated with a same user.

9. The method of claim 1, wherein the first device and the second device are communicatively couple via an end-to-end encrypted channel.

10. The method of claim 9, wherein any intermediate servers between the first device and the second device are unable to read state change information from the end-to-end encrypted channel.

11. A system configured client-to-client message synchronization, the system comprising:
one or more hardware processors configured by machine-readable instructions to:
in response to an indication of a state change for a state of an account on a first device being received through a user interface of the first device, receive the indication of the state change from the first device at a second device, the account being for a messaging application, the second device having access to the account, wherein the state includes one or more of thread deleted, message deleted, message deleted for me, thread archived, thread marked as read, and/or thread marked as unread, wherein the indication of the state change is encrypted by the first device, and wherein the second device decrypts the encrypted indication of the state change;
update a state of the account on the second device based on the indication of the state change for the account on the first device; and
cause display of a view of the user interface of the messaging application on the second device reflecting the updated state of the account on the second device.

12. The system of claim 11, wherein the state includes a current condition of the account regarding stored inputs as to values or contents.

13. The system of claim 11, wherein the state change includes a transition from a first state to a second state.

14. The system of claim 11, wherein the indication of the state change includes a data stanza that is only communicable between peer devices, the peer devices including the first device and the second device.

15. The system of claim 11, wherein the second device sends a retry receipt in response to the second device unsuccessfully decrypting the encrypted indication of the state change.

16. The system of claim 11, wherein undelivered indications of state changes are pruned from an offline queue after breaching one or more of a threshold duration, a threshold number of retries, and/or a threshold number of indications of state changes.

17. The system of claim 11, wherein indications of state changes of a same type are merged if being processed contemporaneously.

18. The system of claim 11, wherein the indication of the state change for the account on the first device is received at the second device via an end-to-end encrypted channel.

19. The system of claim 18, wherein updating the state of the account on the second device includes transitioning the state of the account on the second device from a first state to a second state.

20. A non-transient computer-readable storage medium having instructions embodied thereon, the instructions being executable by one or more processors to perform a method client-to-client message synchronization, the method comprising:
in response to an indication of a state change for a state of an account on a first device being received through a user interface of the first device, receiving the indication of the state change from the first device at a second device, the account being for a messaging application, the second device having access to the account, wherein the state includes one or more of thread deleted, message deleted, message deleted for me, thread archived, thread marked as read, and/or thread marked as unread, wherein the state change includes a transition from a first state to a second state, wherein the indication of the state change is encrypted by the first device, wherein the second device decrypts the encrypted indication of the state change, and wherein the first device and the second device are communicatively couple via an end-to-end encrypted channel;
updating a state of the account on the second device based on the indication of the state change for the account on the first device, wherein any intermediate servers between the first device and the second device are unable to read state change information from the end-to-end encrypted channel; and
causing display of a view of the user interface of the messaging application on the second device reflecting the updated state of the account on the second device.
